(19) United States
(12) Patent Application Publication
(10) Pub. No.: US 2012/0250352 A1
(43) Pub. Date: Oct. 4, 2012

(54) DISPLAY DEVICE

(75) Inventor: Takeaki HIRASAWA, Tokyo (JP)

(73) Assignee: Sony Corporation, Tokyo (JP)

(21) Appl. No.: 13/417,573

(22) Filed: Mar. 12, 2012

(30) Foreign Application Priority Data
Mar. 30, 2011 (JP) 2011-076568

(51) Int. Cl. F21V 7/00; F21V 29/00; F21V 8/00

(52) U.S. Cl. 362/611

(57) ABSTRACT

A display device includes: a casing configured by at least one chassis; a display arranged inside the casing; a light guiding plate arranged on a rear face side of the display and has an outer peripheral face at least a part of which is formed as an incident face on which light is incident; a light source unit including a light source arranged to face the incident face of the light guiding plate on a lateral side of the light guiding plate; and a heat dissipating member, to which the light source unit is attached, that dissipates heat generated when the light source is driven. The heat dissipating member or the light source unit is attached to the light guiding plate, and the heat dissipating member and the light source unit can be moved with respect to the chassis in accordance with expansion or shrinkage of the light guiding plate.

### FIELD

The present technology relates to a technical field of a display device. More particularly, it relates to a technology field for achieving improvement of the use efficiency of light emitted from a light source by attaching a heat dissipating member or a light source unit to a light guiding plate.

### BACKGROUND

In display devices such as a television set and a personal computer, as displays displaying images, for example, liquid crystal panels are used. The display is arranged inside a casing that is configured by a plurality of chassis.

Since the liquid crystal panels are not displays of a self-light emitting type, the above-described display devices are configured such that light as back light is emitted from the rear face side to the liquid crystal panels. Accordingly, in each display device having a display such as a liquid crystal display that is not of the self-light emitting type, a light source unit is arranged which has a light source serving as back light that emits light to a display from the rear face side.

As a light source of the light source unit, for example, a light emitting diode (LED) is used.

There are types of display devices each having a light source serving as such a back light that are so-called side edge types in which the light source is arranged on the lateral side of a light guide plate arranged on a rear face side of a display, and light emitted from the light source is guided by the light guiding plate in a predetermined direction so as to be emitted (for example, see JP-A-2010-60862). In addition, there are types of display devices each having a light source serving as a back light that are so-called direct-under-types in which the light source is arranged on the rear face side of a display, and light emitted from the light source is emitted toward the display.

In the side-edge-type display device, the light source is arranged on the lateral side of the light guiding plate, and accordingly, a decrease in the thickness of the display device can be achieved.

In such a side-edge-type display device, each light source is located so as to face the outer peripheral face (incident face) of the light guiding plate from the lateral side. When the light source is driven (light is emitted), the light source or a driving substrate thereof radiates heat. Accordingly, such a display device is configured such that the light source unit is arranged in a state of being attached to a light dissipating member such as a heat spreader, and heat generated in the light source unit is transferred to a chassis that configures a casing, for example, a back chassis through the heat dissipating member and is discharged to the outside.

The heat dissipating member is attached to the chassis through screwing or the like, and the light guiding plate is positioned in the chassis through a caulking pin or the like.

In the display device configured as described above, in particular, the light guiding plate expands in a direction perpendicular to the thickness direction due to rise in temperature inside the casing that is caused by heat generated at the time of driving the light source, an increase in the ambient temperature, moisture absorption, or the like.

When the expansion of the light guiding plate occurs, there is concern that the damage in the light source, defective driving of the light source, or the like may occur due to contact of the light guiding plate with the light source arranged on the lateral side of the light guiding plate, or damage in the light guiding plate may occur due to the heat of the light source. Accordingly, a predetermined air gap is formed between the lateral side (incident side) of the light guiding plate and the light source with the expansion of the light guiding plate being considered in advance. In addition, this air gap is necessary also for preventing damage in the light source due to contact between the lateral side of the light guiding plate and the light source when an impact is applied to the display device from the outside thereof.

### SUMMARY

However, as described above, a predetermined air gap is formed between the incident face of the light guiding plate and the light source in consideration of the expansion and the like of the light guiding plate, and accordingly, there are problems in that a distance between the incident face of the light guiding plate and the light source is long, the incidence efficiency of light emitted from the light source for the incident face is low, and the use efficiency of light is low.

It is therefore desirable to improve the use efficiency of light emitted from a light source.

An embodiment of the present technology is directed to a display device including: a casing that is configured by at least one chassis; a display that is arranged inside the casing; a light guiding plate that is arranged on a rear face side of the display and has an outer peripheral face at least a part of which is formed as an incident face on which light is incident; a light source unit that includes a light source arranged to face the incident face of the light guiding plate on a lateral side of the light guiding plate; and a heat dissipating member, to which the light source unit is attached, that dissipates heat generated when the light source is driven. The heat dissipating member or the light source unit is attached to the light guiding plate, and the heat dissipating member and the light source unit can be moved with respect to the chassis in accordance with expansion or shrinkage of the light guiding plate.

According to the above-described display device, even in a case where the light guiding plate expands or shrinks, the distance between the incident face of the light guiding plate and the light source is maintained to be constant.

In the above-described display device, it is preferable that the heat dissipating member is attached to the light guiding plate through bonding.

In such a case, since the heat dissipating member is attached to the light guiding plate through bonding, the thickness of a fitting portion of the heat dissipating member for the light guiding plate is configured to be small.

In the above-described display device, it is preferable that a reflective face that reflects light output from the light source and allows the light to be incident on the light guiding plate is formed in a part of the heat dissipating member.

In such a case, by forming the reflective face that reflects light output from the light source and allows the light to be incident on the light guiding plate in a part of the heat dissipating member, the light output from the light source and incident on the reflective face is reflected by the reflective face so as to be incident on the light guiding plate.

In the above-described display device, it is preferable that a reflective member including a reflective face that reflects light output from the light source and allows the light to be incident on the light guiding plate is disposed, and the reflective member is attached to the light guiding plate.

In such a case, since the reflective member including a reflective face that reflects light output from the light source and allows the light to be incident on the light guiding plate is disposed, and the reflective member is attached to the light guiding plate, the light output from the light source and incident by the reflective face is reflected by the reflective face so as to be incident on the light guiding plate.

In the above-described display device, it is preferable that the light source unit is attached to the light guiding plate through bonding.

In such a case, since the light source unit is attached to the light guiding plate through bonding, the thickness of a fitting portion of the light source unit for the light guiding plate is small.

In the above-described display device, it is preferable that the light source unit is attached to the light guiding plate by using an adhesive, and a reflective face that reflects light output from the light source and allows the light to be incident on the light guiding plate is formed in the adhesive.

In such a case, since the light source unit is attached to the light guiding plate by using an adhesive, and the reflective face that reflects light output from the light source and allows the light to be incident on the light guiding plate is formed in the adhesive, the light output from the light source and incident on the reflective face is reflected by the reflective face so as to be incident on the light guiding plate.

In the above-described display device, it is preferable that the heat dissipating member or the light source unit is attached to an outer periphery portion of the light guiding plate.

In such a case, since the heat dissipating member or the light source unit is attached to the outer peripheral portion of the light guiding plate, a portion of the light guiding plate other than the outer periphery portion can be used as a portion having another function.

According to the embodiment of the present technology, the display device includes: the casing that is configured by at least one chassis; the display that is arranged inside the casing; the light guiding plate that is arranged on a rear face side of the display and has an outer peripheral face at least a part of which is formed as an incident face on which light is incident; the light source unit that includes a light source arranged to face the incident face of the light guiding plate on a lateral side of the light guiding plate; and the heat dissipating member, to which the light source unit is attached, that dissipates heat generated when the light source is driven. The heat dissipating member or the light source unit is attached to the light guiding plate, and the heat dissipating member and the light source unit can be moved with respect to the chassis in accordance with expansion or shrinkage of the light guiding plate.

Accordingly, the distance between the light source and the incident faces can be configured to be short, and the amount of light incident from the light source on the light guiding plate increases, and the use efficiency of light output from the light source can be improved.

In one embodiment of the present technology, the heat dissipating member is attached to the light guiding plate through bonding.

Accordingly, the thickness of a fitting portion of the heat dissipating member for the light guiding plate is small, and the thickness of the display device can be configured to be small.

In one embodiment of the present technology, a reflective face that reflects light output from the light source and allows the light to be incident on the light guiding plate is formed in a part of the heat dissipating member.

Accordingly, the use efficiency of light output from the light source can be improved without increasing the number of components.

In one embodiment of the present technology, a reflective member including a reflective face that reflects light output from the light source and allows the light to be incident on the light guiding plate is disposed, and the reflective member is attached to the light guiding plate.

Accordingly, the use efficiency of light output from the light source can be improved.

In one embodiment of the present technology, the light source unit is attached to the light guiding plate through bonding.

Accordingly, the thickness of a fitting portion of the light source unit for the light guiding plate is small, and the thickness of the display device can be configured to be small.

In one embodiment of the present technology, the light source unit is attached to the light guiding plate by using an adhesive, and a reflective face that reflects light output from the light source and allows the light to be incident on the light guiding plate is formed in the adhesive.

Accordingly, the use efficiency of light output from the light source can be improved without increasing the number of components.

In one embodiment of the present technology, the heat dissipating member or the light source unit is attached to an outer periphery portion of the light guiding plate.

Accordingly, a portion of the light guiding plate other than the outer periphery portion can be effectively used as an output face from which light is output, whereby the size of the display device can be configured to be small without obstructing the display of an image or a video.

### BRIEF DESCRIPTION OF THE DRAWINGS

FIG. 1 is a perspective view illustrating a display device.

FIG. 2 is a perspective view illustrating the display device viewed from the side opposite to that of FIG. 1.

FIG. 3 is a cross-sectional view illustrating a part of the display device.

FIG. 4 is a perspective view illustrating parts of a light dissipating member and a light guiding plate in an enlarged scale.

FIG. 5 is an enlarged cross-sectional view illustrating the positions of a light source unit and the like when the light guiding plate expands or shrinks.

FIG. 6 is an enlarged cross-sectional view illustrating a first modified example.

FIG. 7 is an enlarged cross-sectional view illustrating a second modified example.

### DETAILED DESCRIPTION

Hereinafter, a display device according to a preferred embodiment of the present technology will be described with reference to the accompanying drawings.

In the preferred embodiment represented below, the display device according to an embodiment of the present technology is applied to a television receiver displaying an image on a liquid crystal panel.

The applicable range of the present technology is not limited to a television receiver including a liquid crystal panel, and the present technology can be widely applied to various display devices such as other various types of television receivers, a monitor used in a personal computer or the like, or the like that include a light guiding plate and a light source serving as back light and have a display of not a self-light emitting type disposed therein.

### [Configuration of Display Device]

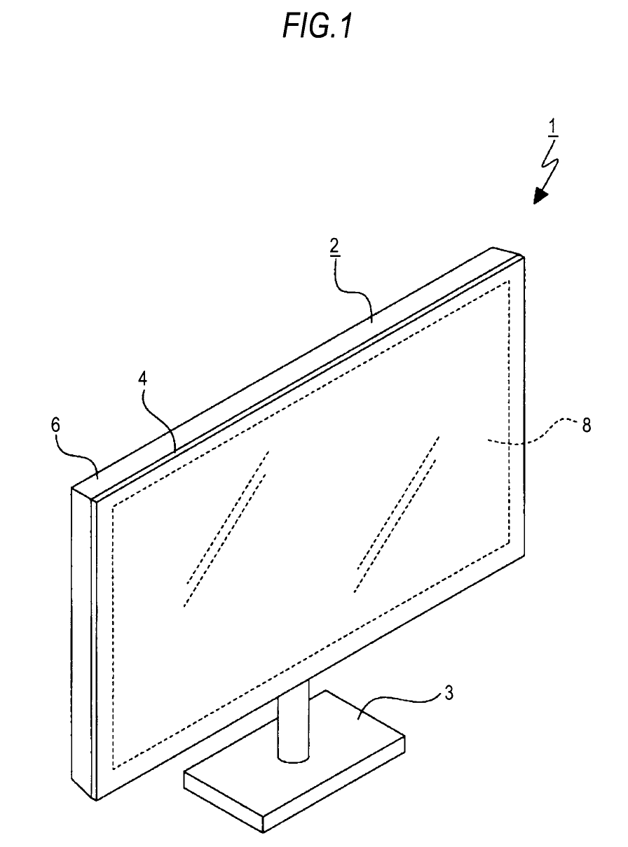

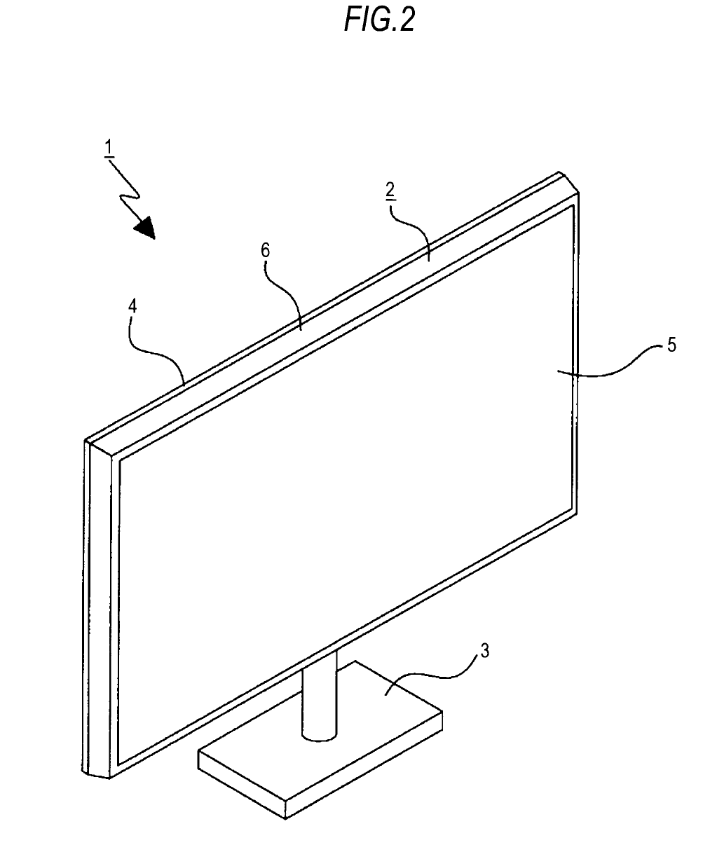

The display device (television receiver) 1 includes a casing 2 and units that are arranged inside the casing 2 (see FIGS. 1 and 2). A space formed on the inside of the casing 2 is formed as an internal space 2a.

In the display device 1, for example, a stand 3 is disposed which is used for placing the display device on a placement face such as a desk.

The casing 2 is formed in a flat shape on the front and rear sides includes, as illustrated in FIGS. 1 to 3, a front chassis 4 that is located on the front side, a back chassis 5 that is located on the back side of the front chassis 4, and a frame chassis 6 that is located between the front chassis 4 and the back chassis 5.

The front chassis 4 is formed in a flat plate shape from transparent glass or resin.

The back chassis 5 is formed from a metal material having a high heat dissipating property in a plate shape, is positioned in a state facing the front chassis 4, and is combined with the back face of the frame chassis 6. In the back chassis 5, a plurality of heat dissipating holes may be formed.

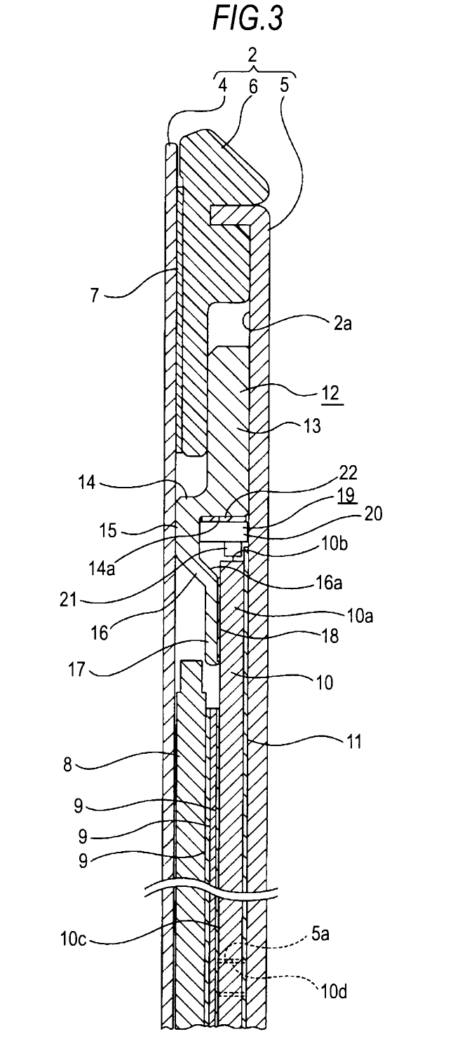

In the back chassis 5, a plurality of fitting bosses 5a, 5a, . . . are disposed (see FIG. 3). The fitting bosses 5a, 5a, . . . , for example, are disposed at positions located close to the outer periphery of the back chassis 5.

The frame chassis 6 is formed in the shape of a rectangular shape, and the outer form thereof is formed to have an approximately same size as that of the front chassis 4. The frame chassis 6 is formed from a resin material or a metal material.

Between the front chassis 4 and the frame chassis 6, a spacer sheet 7 having a frame shape or a band shape is arranged, and the front chassis 4 and the frame chassis 6 are combined together with the spacer sheet 7 interposed therebetween. For example, the spacer sheet has adhesiveness, and the front chassis 4 and the frame chassis 6 are fixed through the spacer sheet.

On the inside of the casing 2, a display (liquid crystal panel) 8 that displays an image is arranged. For example, the display 8 is configured by two polarizing plates interposing a color liquid crystal panel of the transmission type therebetween on the front and rear sides, and, by driving the display 8 in an active matrix mode, a full-color video is displayed.

The display 8 is arranged inside the casing 2 in a state in which the front face thereof is brought into contact with the rear face of the front chassis 4. The outer form of the display 8 is formed to be small than that of the front chassis 4. On the back side of the display 8, a plurality of optical sheets 9, 9 and 9, a light guiding plate 10, and a reflective sheet 11 are sequentially arranged from the front side in contact states.

The optical sheets, 9, 9, and 9, for example, have a function of diffusing light output from the light guiding plate 10. In order to resolve the directivity of light output from the light guiding plate 10, it is necessary for the optical sheets 9, 9, and 9 to have a sufficient diffusion property and low light absorptivity.

The light guiding plate 10 is formed, for example, a transparent material such as acryl in a plate shape having an outer form larger than the outer form of the display 8 and is arranged such that an outer periphery portion 10a thereof is located on the outer side of the outer periphery of the display 8. Out of outer peripheral faces in the thickness direction of the light guiding plate 10, for example, an upper face and a lower face are formed as incident faces 10b and 10b on which light is incident. The front face of the light guiding plate 10 is formed as an output face 10c that outputs light.

In an end portion of the light guiding plate 10 that is located on the outer periphery side, a plurality of fitting holes passing through the front and rear sides or fitting notches 10d, 10d, . . . are formed, and the fitting holes 10d, 10d, . . . , for example, are located at a center portion of the light guiding plate 10 in the vertical direction or a center portion in the horizontal direction. The light guiding plate 10 is attached to the back chassis 5 by inserting the fitting bosses 5a, 5a, . . . into the fitting holes 10d, 10d, . . . .

The reflective sheet 11 has a function of guiding light to the output face 10c by reflecting the light that is incident on the light guiding plate 10 and is to be output from the rear face of the light guiding plate 10.

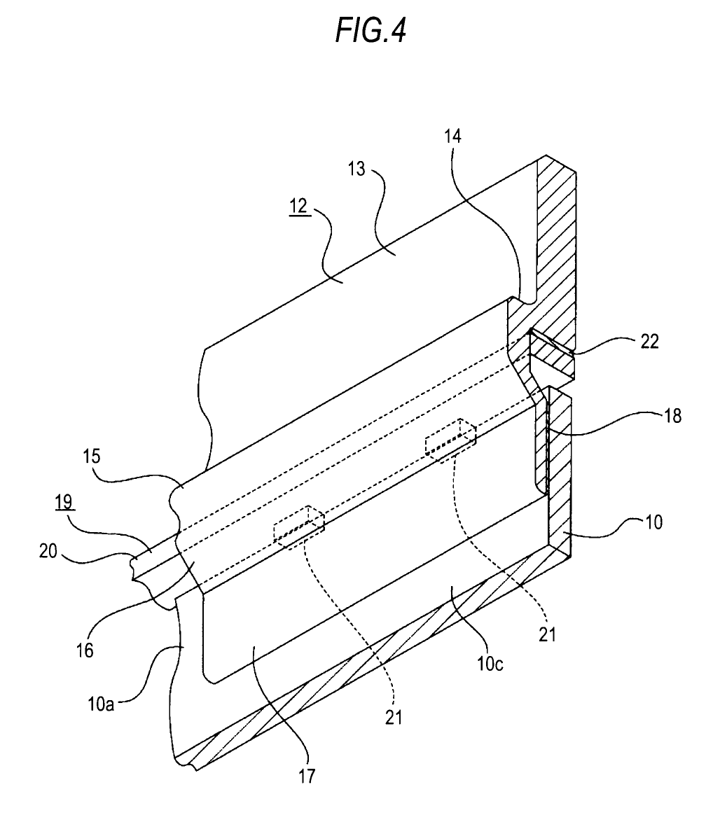

On the upper end side and the lower end side in the internal space 2a of the casing 2, heat dissipating members 12 and 12 that extend in the horizontal direction are arranged (see FIGS. 3 and 4).

The heat dissipating member 12 is formed by: a base portion 13 that is located on the outermost side and faces the front and rear sides; a fitting portion 14 that protrudes to the front side from the inner end portion of the base portion 13; a connection portion 15 that protrudes from the front end portion of the fitting portion 14 to the inner side; an inclined portion 16 that protrudes from the inner end portion of the connection portion 15 so as to be inclined further toward the rear side; and a fitted portion 17 that protrudes from the inner end portion of the inclined portion 16 to the inner side. The inner face of the fitting portion 14 is formed as a fitting face 14a. The inner face of the inclined portion 16 is formed as a reflective face 16a.

In each one of the heat dissipating members 12 and 12, the fitted portion 17 is attached to the front face of both vertical end portions of the outer periphery portion 10a of the light guiding plate 10, for example, through bonding using double sided tapes 18 and 18, adhesives, or the like.

By attaching the heat dissipating members 12 and 12 to the light guiding plate 10 through bonding as above, the thickness of the fitting portion is formed to be small, and the display device 1 can be formed to be thin.

In the state in which the heat dissipating members 12 and 12 are attached to the light guiding plate 10, a state in which the frame chassis 6 and the back chassis 5 are in contact with the base portions 13 and 13 from the front and rear sides or a state in which a minute space is vacant is formed, and the heat dissipating members 12 and 12 can be movable in the vertical direction with respect to the back chassis 5.

To the fitting faces 14a and 14a of the heat dissipating members 12 and 12, light source units 19 and 19 are attached.

The light source unit 19 includes a driving substrate 20 extending in the horizontal direction and a plurality of light sources 21, 21, . . . mounted on the driving substrate 20, and the light sources 21, 21, . . . are positioned so as to be separated from each other in the horizontal direction. As the light sources 21, 21, . . . , for example, light emitting diodes (LEDs) are used. The light sources 21, 21, . . . are positioned so as to face the incident face 10b of the light guiding plate 10, and a distance therebetween, for example, is in the range of 0.2 mm to 0.3 mm.

In the light source units 19 and 19, the driving substrates 20 and 20 are attached to the heat dissipating members 12 and 12, for example, by using adhesives 22 and 22, double sided tapes, or fitting screws.

The light source units 19 and 19 are attached to the heat dissipating members 12 and 12 and thus are moved in accordance with the movement of the heat dissipating members 12 and 12 that are configured to be movable in the vertical direction with respect to the back chassis 5.

### [Optical Path in Display Device]

In the display device 1 configured as above, when light is emitted from the light sources 21, 21, . . . of the light source units 19 and 19, the emitted light is incident on the light guiding plate 10 from the incident faces 10b and 10b and is guided in the vertical direction inside the light guiding plate 10 and is reflected by the inner faces of the light guiding plate 10. The light reflected by the inner faces is transmitted through the output face 10c of the light guiding plate 10, is output to the display 8 as back light through the optical sheets 9, 9, and 9, and is output from the display 8 as video light.

At this time, the light incident on the light guiding plate 10 and is reflected by the reflective sheet 11 is transmitted through the output face 10c of the light guiding plate 10, and is output to the display 8 as back light through the optical sheets 9, 9, and 9, and is output from the display 8 as video light as well.

When light is emitted from the light sources 21, 21, . . . , there is light that is not incident on the incident faces 10b and 10b depending on the outgoing angle of the light. Out of the light that is not incident on the incident faces 10b and 10b, light incident on the reflective faces 16a and 16a of the heat dissipating members 12 and 12 is reflected by the reflective faces 16a and 16a. The light reflected by the reflective faces 16a and 16a is incident on the inside of the light guiding plate 10 and is guided in the vertical direction inside the light guiding plate 10.

By forming the reflective faces 16a and 16a that reflect light output from the light sources 21, 21, . . . and allow the light to be incident on the light guiding plate 10 in the heat dissipating members 12 and 12 as above, the use efficiency of light emitted from the light sources 21, 21, . . . can be improved without increasing the number of components.

### [Operation Performed at Time of Driving Light Source]

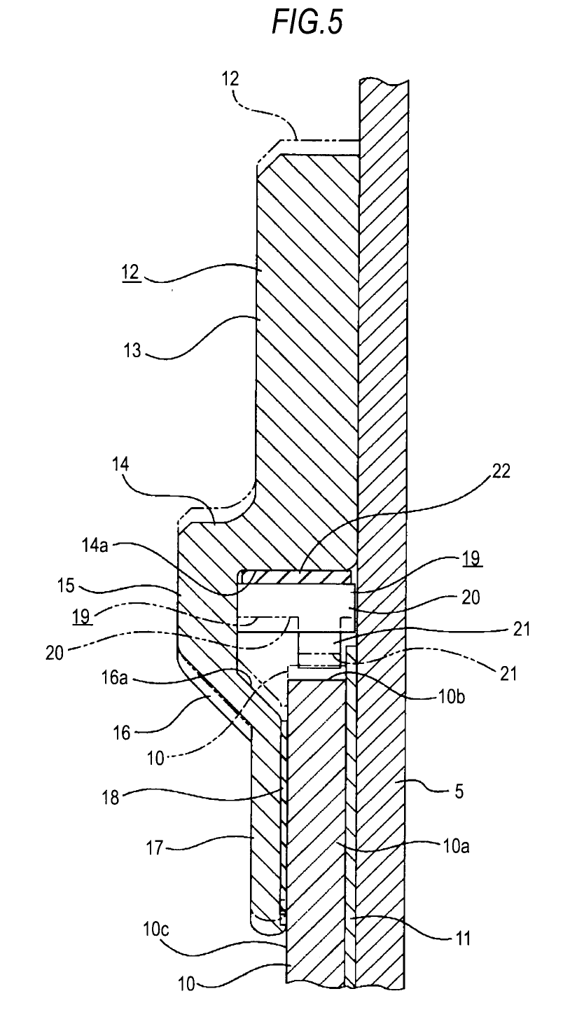

When light is emitted from the light sources 21, 21, . . . as described above, the light source units 19 and 19 dissipate heat. When the light source units 19 and 19 dissipate heat, the temperature of the internal space 2a, each chassis, the light guiding plate, and optical sheets rises, and, particularly, the light guiding plate 10 expands in a direction perpendicular to the thickness direction so as to be lengthened in the horizontal direction and the vertical direction. At this time, the heat dissipating members 12 and 12 are attached to the light guiding plate 10 so as to be movable with respect to the back chassis 5 and thus are moved in the vertical direction with respect to the back chassis 5 integrally with the light source units 19 and 19 in accordance with a change in the length of the light guiding plate 10 in the vertical direction (see FIG. 5). Accordingly, distances between the light sources 21, 21, . . . and the incident faces 10b and 10b of the light guiding plate 10 are maintained to be constant.

On the other hand, when the emission of light from the light sources 21, 21, . . . is stopped, the heat dissipation of the light source units 19 and 19 is stopped, and the temperature of the internal space 2a, each chassis, the light guiding plate, and the optical sheets is lowered, whereby the light guiding plate 10 shrinks in the direction perpendicular to the thickness direction so as to be shortened in the horizontal direction and the vertical direction. At this time, the heat dissipating members 12 and 12 are moved in the vertical direction with respect to the back chassis 5 integrally with the light source units 19 and 19 in accordance with a change in the length of the light guiding plate 10 in the vertical direction. Accordingly, the distance between the light sources 21, 21, . . . and the incident faces 10b and 10b of the light guiding plate 10 are maintained to be constant.

### MODIFIED EXAMPLES

Hereinafter, modified examples of the heat dissipating members and the like will be described.

### First Modified Example

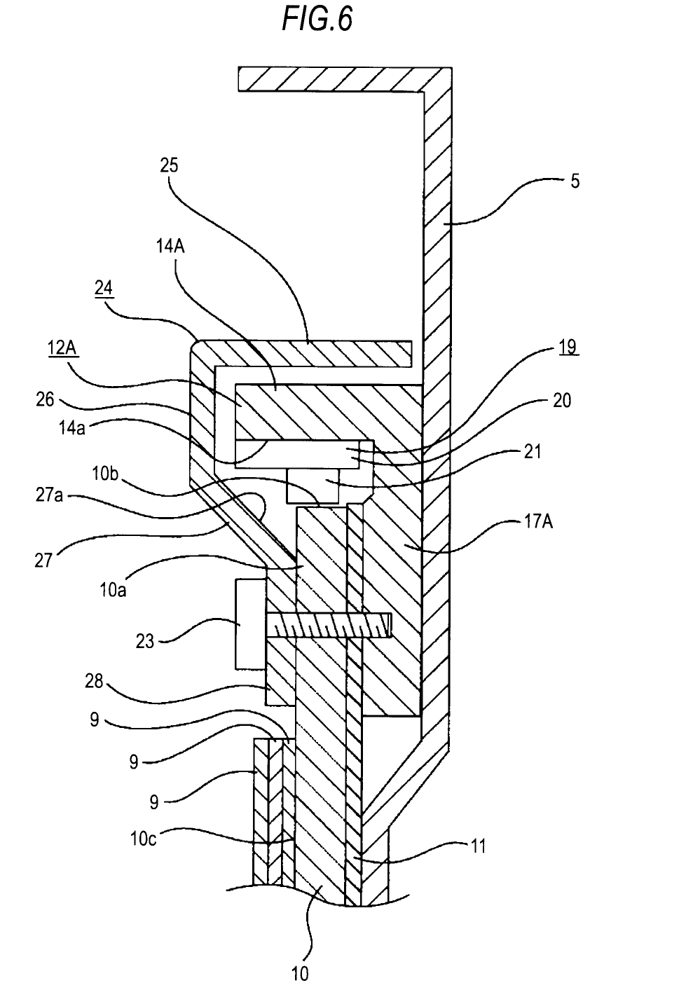

First, a first modified example will be described (see FIG. 6). In the first modified example illustrated as below, there are only differences from the above-described structure having the heat dissipating members 12 that the shape of heat dissipating members is different and a reflective member is arranged. Thus, only portions different from those of the structure having the heat dissipating members 12 will be described in detail, and the same reference numerals are assigned to the other portions that are similar to those of the structure having the heat dissipating members 12, and the description thereof will not be presented.

On the upper end side and the lower end side of the internal space of a casing 2, heat dissipating members 12A and 12A that extend in the horizontal direction are arranged.

The heat dissipating member 12A is formed by a fitting portion 14A that is located on the outermost side and faces the vertical direction and a fitted portion 17A that protrudes from the front end portion of the fitting portion 14A to the inner side. The inner face of the fitting portion 14A is formed as a fitting face 14a.

In each one of the heat dissipating members 12A and 12A, the fitted portion 17A is attached to the rear face of both vertical end portions of the outer periphery portion 10a of the light guiding plate 10, for example, by using a double sided tape, an adhesive, or fitting screws 23 and 23.

In the state in which the heat dissipating members 12A and 12A are attached to the light guiding plate 10, a state in which rear faces of the fitted portions 17A and 17A are in contact with the back chassis 5, and the heat dissipating members 12A and 12A are configured to be movable in the vertical direction with respect to the back chassis 5.

To the fitting faces 14a and 14a of the heat dissipating members 12A and 12A, light source units 19 and 19 are attached. The light source units 19 and 19 are attached to the heat dissipating members 12A and 12A and thus are moved in accordance with the movement of the heat dissipating members 12A and 12A that are configured to be movable in the vertical direction with respect to the back chassis 5.

To an outer periphery portion 10a of the light guiding plate 10, a reflective member 24 is attached. The reflective member 24 is formed by: an outer face portion 25 that is located on the outermost side and faces the upper and lower sides; a connection face portion 26 that protrudes to the inner side from the front end portion of the outer face portion 25; an inclined face portion 27 that protrudes from the inner end portion of the connection face portion 26 so as to be inclined further toward the rear side; and a fitted face portion 28 that protrudes from the inner end portion of the inclined face portion 27 to the inner side. The inner face of the inclined face portion 27 is formed as a reflective face 27a.

In each one of the reflective members 24 and 24, the fitted face portion 28 is attached to the front face of both vertical end portions of the outer periphery portion 10a of the light guiding plate 10, for example, through a double sided tape, an adhesive, or fitting screws 23 and 23. Since the reflective members 24 and 24 and the heat dissipating members 12A and 12A are attached together to the light guiding plate 10 by using the fitting screws 23 and 23, the reflective members 24 and 24 and the heat dissipating members 12A and 12A can be attached to the light guiding plate 10 by one operation, whereby the workability can be improved in the attachment operation.

In the state in which the reflective members 24 and 24 are attached to the light guiding plate 10, the light source units 19 and 19 are covered with the connection face portions 26 and 26 and the inclined face portions 27 and 27 on the front side.

When light is emitted from the light sources 21, 21, . . . , there is light that is not incident on the incident faces 10b and 10b of the light guiding plate 10 depending on the outgoing angle of the light. Out of the light that is not incident on the incident faces 10b and 10b, light incident on the reflective faces 27a and 27a of the reflective members 24 is reflected by the reflective faces 27a and 27a. The light reflected by the reflective faces 27a and 27a is incident on the inside of the light guiding plate 10 and is guided in the vertical direction inside the light guiding plate 10.

By arranging the reflective members 24 and 24 that reflect light output from the light sources 21, 21, . . . and allow the light to be incident on the light guiding plate 10 as above, the use efficiency of light emitted from the light sources 21, 21, . . . can be improved.

When the light guiding plate 10 expands or shrinks so as to change in length in the vertical direction, the heat dissipating members 12A and 12A, the light source units 19 and 19, and the reflective members 24 and 24 are moved in the vertical direction with respect to the back chassis 5 in accordance with a change in length of the light guiding plate 10 in the vertical direction. Accordingly, distances between the light sources 21, 21, . . . and the incident faces 10b and 10b of the light guiding plate 10 are maintained to be constant.

### Second Modified Example

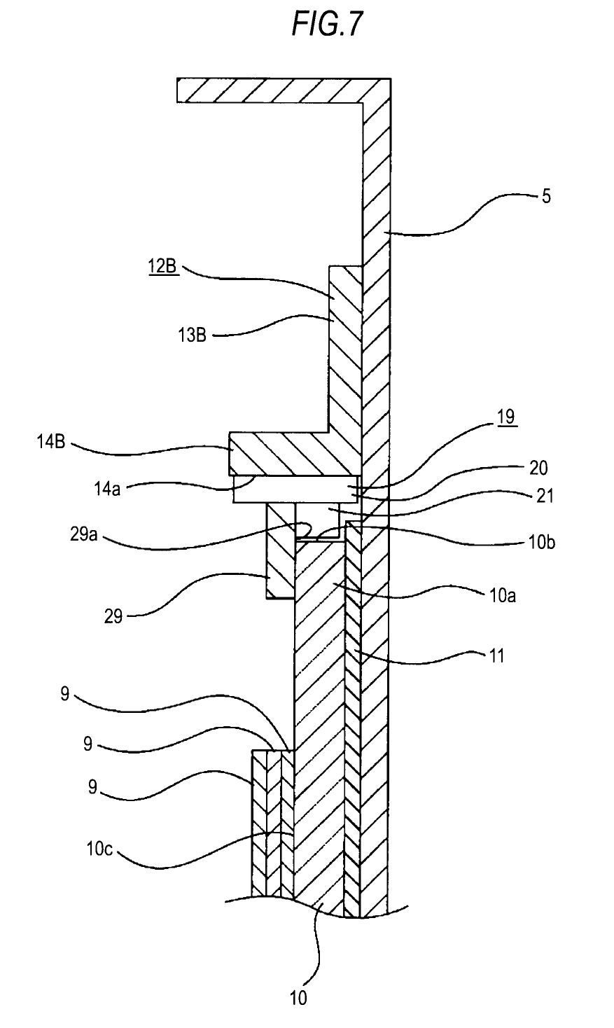

Next, a second modified example will be described (see FIG. 7). In the second modified example illustrated as below, there are only differences from the above-described structure having the heat dissipating members 12 that the shape of heat dissipating members is different and light sources are attached to the light guiding plate. Thus, only portions different from those of the structure having the heat dissipating members 12 will be described in detail, and the same reference numerals are assigned to the other portions that are similar to those of the structure having the heat dissipating members 12, and the description thereof will not be presented.

On the upper end side and the lower end side of the internal space of a casing 2, heat dissipating members 12B and 12B that extend in the horizontal direction are arranged.

The heat dissipating member 12B is formed by a base face portion 13B that face the front and rear sides and a fitting portion 14B that protrudes from the inner end portion of the base face portion 13B to the front side. The inner face of the fitting portion 14B is formed as a fitting face 14a.

To the fitting faces 14a and 14a of the heat dissipating members 12B and 12B, light source units 19 and 19 are attached. The light sources 21, 21, . . . of the light source units 19 and 19 are attached to the front face of both vertical end portions of the outer periphery portion 10a of the light guiding plate 10 by using adhesives 29 and 29, for example, ultraviolet curable adhesives. The front faces of the light sources 21, 21, . . . and the front face of the outer periphery portion 10a of the light guiding plate 10 are coated with adhesives 29 and 29. The adhesives 29 and 29 have a function of reflecting light, and, for example, the rear faces serves as reflective faces 29a and 29a.

By attaching the light sources 21, 21, . . . to the light guiding plate 10 through bonding as above, the fitting portion is thin, and a decrease in the thickness of the display device 1 can be achieved.

In the state in which the light sources 21, 21, . . . are attached to the light guiding plate 10, a state in which rear faces of the base face portions 13B and 13B of the heat dissipating members 12B and 12B are in contact with the back chassis 5, and the light source units 19 and 19 and the heat dissipating members 12B and 12B are integrally configured to be movable in the vertical direction with respect to the back chassis 5.

When light is emitted from the light sources 21, 21, . . . , there is light that is not incident on the incident faces 10b and 10b of the light guiding plate 10 depending on the outgoing angle of the light. Out of the light that is not incident on the incident faces 10b and 10b, light incident on the reflective faces 29a and 29a of the adhesives 29 and 29 is reflected by the reflective faces 29a and 29a. The light reflected by the reflective faces 29a and 29a is incident on the inside of the light guiding plate 10 and is guided in the vertical direction inside the light guiding plate 10.

By attaching the light sources 21, 21, . . . to the light guiding plate 10 by using the adhesives 29 and 29 having the reflective faces 29a and 29a that reflect light emitted from the light sources 21, 21, . . . and allow the light to be incident on the light guiding plate 10 as above, the use efficiency of light emitted from the light sources 21, 21, . . . can be improved without increasing the number of components.

In addition, by forming the reflective faces 29a and 29a in the adhesives 29 and 29, it is not necessary to form the reflective faces in the heat dissipating members, and the size of the heat dissipating members 12B and 12B can be formed to be small as that much, whereby a decrease in the size of the display device 1 can be achieved.

When the light guiding plate 10 expands or shrinks so as to change in length in the vertical direction, the heat dissipating members 12B and 12B and the light source units 19 and 19 are moved in the vertical direction with respect to the back chassis 5 in accordance with a change in length of the light guiding plate 10 in the vertical direction. Accordingly, distances between the light sources 21, 21, . . . and the incident faces 10b and 10b of the light guiding plate 10 are maintained to be constant.

### CONCLUSION

As described above, according to the display device 1, the heat dissipating members 12, 12, 12A, and 12A or the light source units 19 and 19 are attached to the light guiding plate 10, and the heat dissipating members 12, 12, 12A, 12A, 12B, and 12B and the light source units 19 and 19 are configured to be movable with respect to the back chassis 5 in accordance with the expansion or shrinkage of the light guiding plate 10.

Accordingly, even in a state in which the light guiding plate 10 expands or shrinks, the distances between the light sources 21, 21, . . . and the incident faces 10b and 10b of the light guiding plate 10 are maintained to be constant. Therefore, the distances between the light sources 21, 21, . . . and the incident faces 10b and 10b can be shortened as that much, whereby the amount of light incident from the light sources 21, 21, . . . on the light guiding plate 10 is increased.

Since the amount of light incident from the light sources 21, 21, . . . on the light guiding plate 10 is increased as above, the use efficiency of the light emitted from the light sources 21, 21, . . . can be improved.

In addition, since the distances between the light sources 21, 21, . . . and the incident faces 10b and 10b of the light guiding plate 10 do not change regardless of the expansion of shrinkage of the light guiding plate 10, the deformation of each member such as a bent state, or an allowable error at the time of manufacturing the components such as the chassis and the light guiding plate, there is no change in the amount of light incident from the light sources 21, 21, . . . on the light guiding plate 10, whereby uneven luminance of light output from the display 8 can be suppressed.

Furthermore, since the use efficiency of the light emitted from the light sources 21, 21, . . . can be improved, the number of the light sources 21, 21, . . . can be decreased as that much, whereby a decrease in the number of components or the manufacturing cost can be achieved.

In addition, since the heat dissipating members 12, 12, 12A, and 12A or the light source units 19 and 19 are attached to the light guiding plate 10, even in a state in which an impact is applied to the display device 1 from the outside, the light sources 21, 21, . . . are not brought into contact with the incident faces 10b and 10b, and the light sources 21, 21, . . . are prevented from being damaged.

In addition, the use efficiency of light is improved by increasing the amount of light incident from the light sources 21, 21, . . . on the light guiding plate 10, and accordingly, the thickness of the light guiding plate 10 can be formed to be small, and the thickness of the display device 1 can be configured to be small.

Furthermore, since the heat dissipating members 12, 12, 12A, and 12A or the light sources 21, 21, . . . of the light source units 19 and 19 are attached to the outer periphery portion 10a of the light guiding plate 10, a portion of the front face of the light guiding plate 10 other than the outer periphery portion 10a can be effectively used as an output face 10c from which light is output, whereby the size of the display device 1 can be configured to be small without obstructing the display of an image or a video.

### [Others]

In the description presented above, although an example has been illustrated in which the heat dissipating members 12, 12, 12A, 12A, 12B, and 12B and the light source units 19 and 19 are arranged in the internal space 2a of the casing 2, the arrangement positions of the heat dissipating members 12 and 12 and the like are not limited to the vertical end portions of the internal space 2a and may be located at one of the upper end portion and the lower end portion of the internal space 2a.

In addition, the arrangement positions of the heat dissipating members 12 and 12 and the like are not limited to both the vertical end portions of the internal space 2a and may be located in both horizontal end portions, one of both horizontal end portions, or four end portions located on the upper, lower, left and right sides.

Furthermore, although an example has been illustrated in which the LEDs are used as the light sources 21, 21, . . . in the description presented above, other kinds of the light sources 21, 21, . . . such as fluorescent tubes may be used.

In addition, in a case where the light sources 21, 21, . . . are in contact with the incident faces 10b and 10b of the light guiding plate 10, there is concern that the light guiding plate 10 is melted by heat generated at the time of driving the light sources 21, 21, . . . . Accordingly, it is preferable that a slight air gap is formed between the light sources 21, 21, . . . and the incident faces 10b and 10b.

### [Present Technology]

The present technology may be implemented as the following configurations.

(1) A display device including: a casing that is configured by at least one chassis; a display that is arranged inside the casing; a light guiding plate that is arranged on a rear face side of the display and has an outer peripheral face at least a part of which is formed as an incident face on which light is incident; a light source unit that includes a light source arranged to face the incident face of the light guiding plate on a lateral side of the light guiding plate; and a heat dissipating member, to which the light source unit is attached, that dissipates heat generated when the light source is driven. The heat dissipating member or the light source unit is attached to the light guiding plate, and the heat dissipating member and the light source unit can be moved with respect to the chassis in accordance with expansion or shrinkage of the light guiding plate.

(2) The display device described in (1), wherein the heat dissipating member is attached to the light guiding plate through bonding.

(3) The display device described in (1) or (2), wherein a reflective face that reflects light output from the light source and allows the light to be incident on the light guiding plate is formed in a part of the heat dissipating member.

(4) The display device described in any one of (1) to (3), wherein a reflective member including a reflective face that reflects light output from the light source and allows the light to be incident on the light guiding plate is disposed, and the reflective member is attached to the light guiding plate.

(5) The display device described in any one of (1) to (4), wherein the light source unit is attached to the light guiding plate through bonding.

(6) The display device described in any one of (1) to (5), wherein the light source unit is attached to the light guiding plate by using an adhesive, and a reflective face that reflects light output from the light source and allows the light to be incident on the light guiding plate is formed in the adhesive.

(7) The display device described in any one of (1) to (6), wherein the heat dissipating member or the light source unit is attached to an outer periphery portion of the light guiding plate.

All the specific shapes and structures of the units illustrated in the above-described preferred embodiment of the present technology are merely examples of embodiments when the present technology is implemented, and it should be understood that the technical scope of the present technology is not interpreted to be limited thereby.

The present disclosure contains subject matter related to that disclosed in Japanese Priority Patent Application JP 2011-076568 filed in the Japan Patent Office on Mar. 30, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a casing that is configured by at least one chassis;
a display that is arranged inside the casing;
a light guiding plate that is arranged on a rear face side of the display and has an outer peripheral face at least a part of which is formed as an incident face on which light is incident;
a light source unit that includes a light source arranged to face the incident face of the light guiding plate on a lateral side of the light guiding plate; and
a heat dissipating member, to which the light source unit is attached, that dissipates heat generated when the light source is driven,
wherein the heat dissipating member or the light source unit is attached to the light guiding plate, and the heat dissipating member and the light source unit can be moved with respect to the chassis in accordance with expansion or shrinkage of the light guiding plate.

2. The display device according to claim 1, wherein the heat dissipating member is attached to the light guiding plate through bonding.

3. The display device according to claim 1, wherein a reflective face that reflects light output from the light source and allows the light to be incident on the light guiding plate is formed in a part of the heat dissipating member.

4. The display device according to claim 1,
wherein a reflective member including a reflective face that reflects light output from the light source and allows the light to be incident on the light guiding plate is disposed, and
wherein the reflective member is attached to the light guiding plate.

5. The display device according to claim 1, wherein the light source unit is attached to the light guiding plate through bonding.

6. The display device according to claim 5,
wherein the light source unit is attached to the light guiding plate by using an adhesive, and
wherein a reflective face that reflects light output from the light source and allows the light to be incident on the light guiding plate is formed in the adhesive.

7. The display device according to claim 1, wherein the heat dissipating member or the light source unit is attached to an outer periphery portion of the light guiding plate.
